(19) United States
(12) Patent Application Publication
(10) Pub. No.: US 2019/0123654 A1
(43) Pub. Date: Apr. 25, 2019

(54) Circuit Arrangement for Switched-Mode Power Conversion with Improved Efficiency

(71) Applicant: Microchip Technology Incorporated, Chandler, AZ (US)

(72) Inventors: Greg Dix, Tempe, AZ (US); Joseph Depew, Johns Island, SC (US)

(73) Assignee: Microchip Technology Incorporated, Chandler, AZ (US)

(21) Appl. No.: 16/167,592

(22) Filed: Oct. 23, 2018

Related U.S. Application Data
(60) Provisional application No. 62/576,938, filed on Oct. 25, 2017.

(51) Int. Cl. H02M 3/335

(52) U.S. Cl. CPC H02M 3/33515; H02M 2001/0012

(57) ABSTRACT

A circuit arrangement for switched mode power conversion is disclosed, which circuit arrangement comprises at least an input for receiving an input voltage from a power supply, an output to provide an output voltage to a load, an energy storage device; a plurality of controllable switching devices; a first controllable voltage source, configured to provide a first control voltage to one or more of the plurality of controllable switching devices, and at least a second controllable voltage source, configured to provide a second control voltage to one or more of the plurality of controllable switching devices. To improve the efficiency of the circuit arrangement, the first and the second controllable voltage sources are configured to allow independent control of the first and second control voltages.

### RELATED PATENT APPLICATION

This application claims priority to U.S. Provisional Patent Application No. 62/576,938 filed Oct. 25, 2017, the entire contents of which are hereby incorporated by reference for all purposes.

### TECHNICAL FIELD

The present disclosure relates to power converters and, more particularly, to control of a switched-mode power converter.

### BACKGROUND

Power converters and in particular switched-mode power converters are used in a variety of applications to provide AC/DC and DC/DC conversion. For example, switched-mode power converters, also referred to as switched-mode power supplies (SMPS), are widely used in computer and mobile phone power supply units to provide the necessary operating voltages from input voltages that differ from the required voltage.

A typical item of concern when designing power converters relates to conversion efficiency. It should be readily apparent that power losses should be minimized to increase the overall efficiency of the converter and also to reduce the generation of heat, which may be difficult to dissipate depending on the design and the respective application.

Typical switches used in a switched-mode power converters have a standardized switching profile. For example, typical field-effect transistors (FETs) are provided with a common and fixed gate drive voltage profile. However, each individual FET may have a profile that differs from the common gate drive voltage profile, leading to inefficient, i.e., non-optimized switching operation.

### SUMMARY

An object thus exists to provide a circuit arrangement and method for switched-mode power conversion that allows to operate a corresponding circuit efficiently.

The object is solved by a circuit arrangement, a control circuit, and methods for switched boundary mode power conversion according to the independent claims. The dependent claims as well as the following description contain various embodiments of the invention.

In one aspect, a circuit arrangement for switched mode power conversion is provided, which comprises at least an input for receiving an input voltage from a power supply, an output to provide an output voltage to a load, an energy storage device, a plurality of controllable switching devices, a first controllable voltage source, configured to provide a first control voltage to one or more of the plurality of controllable switching devices, and at least a second controllable voltage source, configured to provide a second control voltage to one or more of the plurality of controllable switching devices. According to the present aspect, the first and at least the second controllable voltage sources are configured to allow independent control of the first and second control voltages.

### BRIEF DESCRIPTION OF THE DRAWINGS

The above and other objects, features, and advantages of the current invention will become apparent from the following discussion of various embodiments. In the FIGS.,

FIG. 1 shows a schematic block diagram of an embodiment of a circuit arrangement for switched mode power conversion;

FIG. 2 shows a schematic block diagram of an embodiment of a control circuit for the circuit arrangement of FIG. 1; and

FIGS. 3 to 7 illustrate the operation of the circuit arrangement of the embodiment of FIG. 1 during an efficiency optimization procedure.

### DETAILED DESCRIPTION

Technical features described in this application can be used to construct various embodiments of integrated circuit devices. Some embodiments of the invention are discussed so as to enable one skilled in the art to make and use the invention.

As discussed in the preceding, and in one aspect, a circuit arrangement for switched mode power conversion is provided, which comprises at least an input for receiving an input voltage from a power supply, an output to provide an output voltage to a load, an energy storage device, a plurality of controllable switching devices, a first controllable voltage source, configured to provide a first control voltage to one or more of the plurality of controllable switching devices, and at least a second controllable voltage source, configured to provide a second control voltage to one or more of the plurality of controllable switching devices. According to the present aspect, the first and at least the second controllable voltage sources are configured to allow independent control of the first and second control voltages.

One basic idea of the invention is to provide at least two controllable voltage sources, supplying independent control voltages to respective groups of one or more controllable switching devices per group. Thus, it is possible to better adapt the control voltages to the respective groups of switching devices, leading to an improved switching efficiency.

In the context of the present discussion, the term “switched-mode power conversion” is understood as voltage/current conversion between an input and an output using a switching device. A corresponding circuit arrangement for switched-mode power conversion, also referred herein as a “converter circuit”, comprises at least an energy storage device and a switching device for storing input energy temporarily and then releasing that energy to the output at a different voltage and/or current.

An “energy storage device” in the present context is understood as a device for storing electrical energy at least temporarily. For example, an energy storage device may comprise one or more inductors/inductances and/or one or more capacitors/capacitances.

The switching device in the present context may be of any suitable type to control an electrical current. The switching device may comprise for example one or more semiconductor switches, such as bipolar transistors, field-effect transistors, MOSFETs, IGBTs, SiCs, GANs, etc.

The first controllable voltage source and the second controllable voltage source according to the present aspect may be of any suitable type to provide a control voltage. While the first controllable voltage source is configured to provide a first control voltage to one or more of the plurality of controllable switching devices, the second controllable voltage source is configured to provide a second control voltage to one or more of the plurality of controllable switching devices. The controllable voltage sources may be connected with the respective controllable switching devices over suitable connections.

In some embodiments, the assignment of the first and second controllable voltage sources to the controllable switching devices is mutually exclusive, meaning that any given switching device is provided with the control voltage of one controllable voltage source, only.

In some embodiments, more than two controllable voltage sources are provided, each of which may provide a corresponding control voltage to one or more of the controllable switching devices. In some embodiments, a dedicated controllable voltage source is arranged to provide a control voltage to each of the plurality of controllable switching devices.

In some embodiments, at least some of the controllable switching devices are semiconductor switching devices having a control input, wherein the control voltage is provided to the control input of the respective switching device.

In some embodiments, one or more of the controllable voltage sources comprise at least one low-dropout regulator, which further improves the overall efficiency of the circuit arrangement.

In some embodiments, the controllable voltage sources are configured to receive an input signal, corresponding to the input voltage, and wherein the respective control voltage depends on the input signal.

In some embodiments, the controllable voltage sources are configured to receive reference signals, and wherein the respective control voltage depends on the respective reference signal received and the input signal. The reference signals allow “fine tuning” the control voltage and thus adapt the operation of the controllable voltage source to the respective switching device(s) that are controlled. Each reference signal is independent from the other reference signals. In some embodiments, the reference signals are provided by a signal processor or by a digital controller.

In some embodiments, the digital controller is configured to control the reference signals for improved efficiency of the circuit arrangement. For example, the digital controller may comprise a table based with “n” dimensions based on available parameters and/or various functions based on any available parameter. In one example, the output current demand would be used to change the control voltage.

In some embodiments, the digital controller is configured to control the reference signals based on one or more of frequency, voltage output, and current output.

In some embodiments, the digital controller comprises a user interface that allows configuration of the reference signals. In some embodiments, pre-programmed optimization profiles may be selected. In other embodiments, a configuration profile is fully customizable.

In some embodiments, the circuit arrangement further comprises an analog controller, wherein the controllable voltage sources are integrally formed with the analog controller. When combined with a digital controller, and in some embodiments, both, the analog and digital controllers may be formed as a part of the same chip or die. Alternatively, the analog and digital controllers may be formed separately from each other. In such case, the analog controller may be provided as a “front end”, while the digital controller may be provided as a “back end”.

In some embodiments, the circuit arrangement is a synchronous switched mode power converter.

In some embodiments, the circuit arrangement comprises a high side controllable switching device and a low side controllable switching device, wherein the first controllable voltage source is configured to control the high side controllable switching device and the second controllable voltage source is configured to control the low side controllable switching device.

In another aspect, a control circuit for a switched mode power converter with a plurality of controllable switching devices is provided. The control circuit comprises at least a first controllable voltage source, configured to provide a first control voltage to one or more of the plurality of controllable switching devices; and at least a second controllable voltage source, configured to provide a second control voltage to one or more of the plurality of controllable switching devices; wherein the first and the second controllable voltage sources are configured to allow independent control of the first and second control voltages.

In some embodiments, the circuit arrangement of the present aspect is configured according to one or more embodiments of the preceding aspect. With respect to the terms used in the present aspect, reference is made to the definitions of the preceding aspect.

In another aspect, a method of control of a circuit arrangement for switched mode power conversion is provided. In this aspect, the circuit arrangement comprising at least a plurality of controllable switching devices. The method of this aspect comprising providing a first control voltage to one or more of the plurality of controllable switching devices; and providing at least a second control voltage to one or more of the plurality of controllable switching devices; wherein the first and the second controllable voltage sources are independently controlled.

In some embodiments, the circuit arrangement of the present aspect is configured according to one or more embodiments of the preceding aspects. With respect to the terms used in the present aspect, reference is made to the definitions of the preceding aspects.

In another aspect, a method of control of a circuit arrangement for switched mode power conversion is provided. In this aspect, the circuit arrangement comprises one or more controllable switching devices. The method comprises providing a first control voltage to the one or more controllable switching devices; and optimizing the first control voltage for increased efficiency of the circuit arrangement.

In some embodiments, the circuit arrangement of the present aspect is configured according to one or more embodiments of the preceding aspects. With respect to the terms used in the present aspect, reference is made to the definitions of the preceding aspects.

Reference will now be made to the drawings in which the various elements of embodiments will be given numerical designations and in which further embodiments will be discussed.

Specific references to components, modules, units, devices, sections, parts, process steps, and other elements are not intended to be limiting. Further, it is understood that like parts bear the same or similar reference numerals, when referring to alternate figures. It is further noted that the figures are schematic and provided for guidance to the skilled reader and are not necessarily drawn to scale. Rather, the various drawing scales, aspect ratios, and numbers of components shown in the figures may be purposely distorted to make certain features or relationships easier to understand.

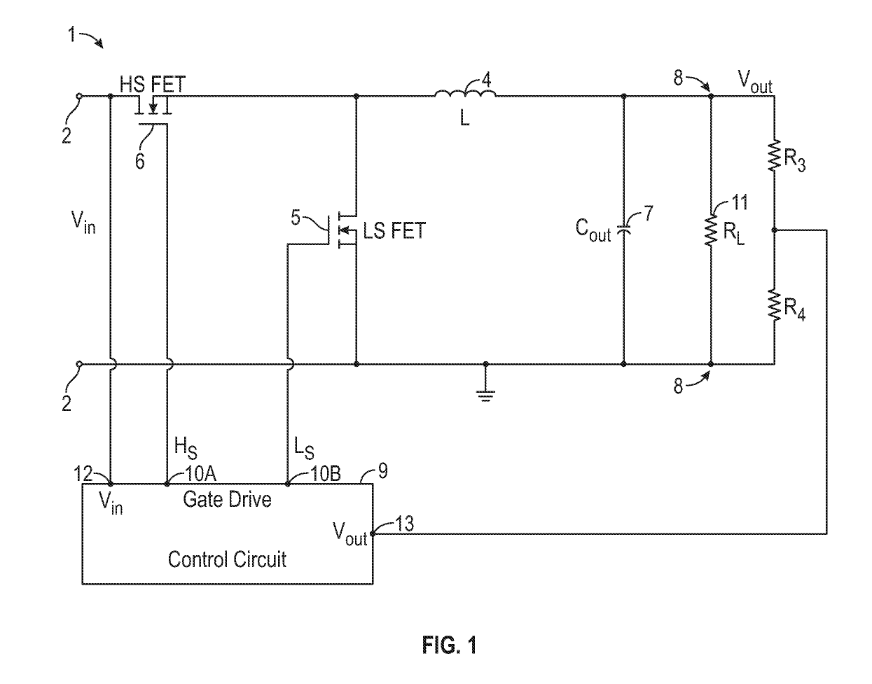

FIG. 1 shows a schematic block diagram of an embodiment of a circuit arrangement for switched-mode power conversion, namely in the instant embodiment, a switched-mode synchronous buck converter 1.

The buck converter circuit 1 comprises an input or input stage 2, configured for connection with a voltage source, an energy storage device in the form of an inductor 4, MOSFET switching devices 5 and 6, output capacitor 7, output 8, and control circuit 9. As will be apparent, MOSFET 6 in a synchronous buck converter replaces the otherwise typical freewheeling diode to improve the efficiency of the circuit 1.

The general operation of circuit 1 corresponds to that of a typical synchronous buck converter: inductor 4 is charged when MOSFET 6 (high-side) is in the on state and MOSFET 5 (low-side) is in the off state. Once inductor 4 is charged to a predefined level, MOSFET 6 is switched to the off state and MOSFET 5 is switched to the on state, so that a current path is given through the load 11, the latter of which is shown in FIG. 1 as a variable resistance. The energy stored in the inductor 4 during the off state of MOSFET 6 is discharged into the load 11 and the cycle is repeated.

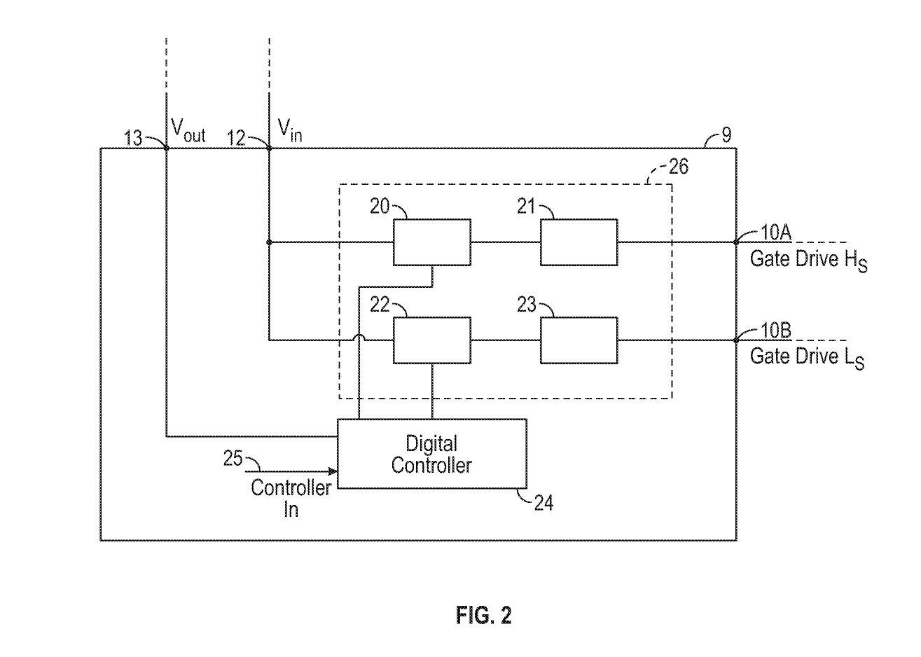

The operation of circuit 1 is controlled by control circuit 9, which in the present embodiment is a mixed-signal integrated circuit, having an analog controller and a digital controller part. The details of control circuit 9 is discussed in the following with reference to FIG. 2.

FIG. 2 shows a schematic block diagram of an embodiment of a control circuit chip 9 as used in the circuit arrangement of FIG. 1.The control circuit chip 9 comprises a digital controller 24, which in this embodiment serves as the “back end” and an analog controller 26, which in this embodiment serves as the “front end”. As will be appreciated by one skilled in the art, the analog controller 26 allows a relatively fast operation for an efficient control of the MOSFETs 5 and 6, while the digital controller 24 allows to provide additional control and “fine tuning”, as discussed in the following in more detail.

To drive the gates of the two MOSFETs 5, 6, the analog controller of control circuit chip 9 comprises associated gate drivers, namely a high side driver 21 and a low side driver 23. The drivers 21 and 23 operate in the typical way, namely to amplify the received control voltages. The respective control voltages are provided by controllable voltage sources 20 and 22, as shown. The controllable voltage sources are implemented with low dropout regulators in the present embodiment. Each of the controllable voltage sources 20 and 22 are supplied with a signal, supplied to connector 12 of the control circuit 9. The signal corresponds to the input voltage of the circuit 1.

The controllable voltage sources 20 and 22 further receive independent reference signals from the digital controller 24. These reference signals are provided to adapt the gate drive voltages to the respective MOSFET 5 and 6. As the current inventors have ascertained, typical FETs have specified gate drive voltages, which however do not result in an optimized efficiency in all operating conditions. Accordingly, the reference signals allow to “fine tune” the gate drive voltages to the individual FET 5 and 6.

The digital controller 24 according to the present embodiment comprises a control input 25, which is a digital interface for a corresponding user interface (not shown). The digital controller 24 may employ various control strategies. In the present embodiment, the control input 25 allows to execute an efficiency optimization procedure to obtain reference signal settings that result in a high efficiency. It is noted that the following efficiency optimization procedure is an example of a characterization procedure. The specifics of the optimization procedure may depend on the specific circuit design.

Once the calibration procedure is started, the digital controller 24 drives the MOSFETs 5 and 6 with different gate voltages over a range of output load settings. As shown in FIGS. 1 and 2, the digital controller 24 receives a signal, corresponding to the output voltage VOUT over terminal 13 and consequently, a voltage divider, formed by resistors R3 and R4, arranged at the output of circuit 1.

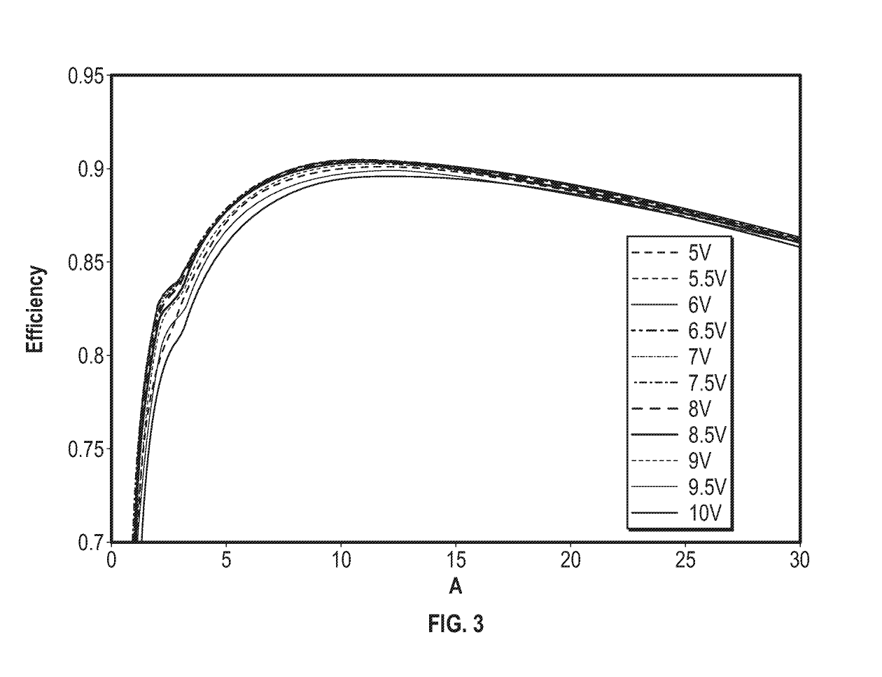

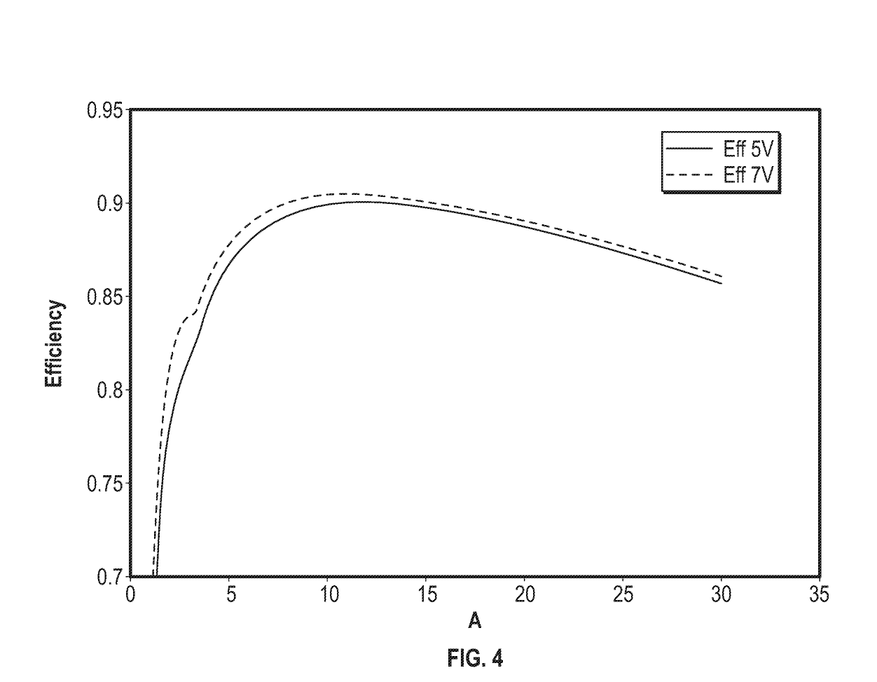

In a first step, the high side gate drive voltage remains at the specification of MOSFET 6. The low side gate drive voltage is varied between 5V and 10V in 0.5V increments. For every gate drive voltage setting, the output load is varied using variable resistor RL 11. FIG. 3 shows the resulting exemplary data, recorded by the digital controller 24. The highest efficiency results for a low side gate drive voltage of 7V, followed by a gate drive voltage of 5V. FIG. 4 shows the graphs for these two gate drive voltages separately, from the other tested gate drive voltages.

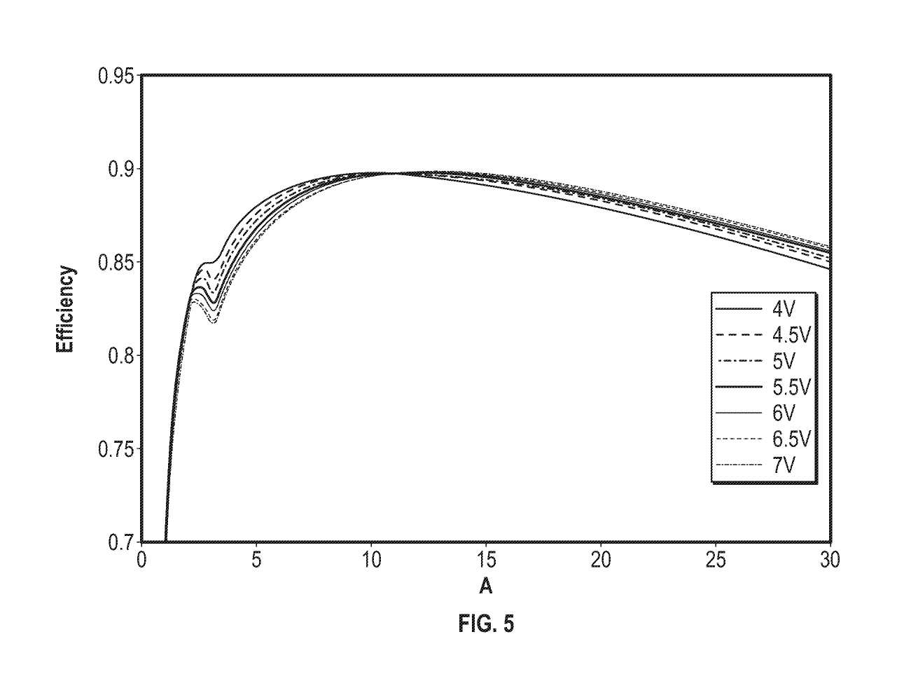

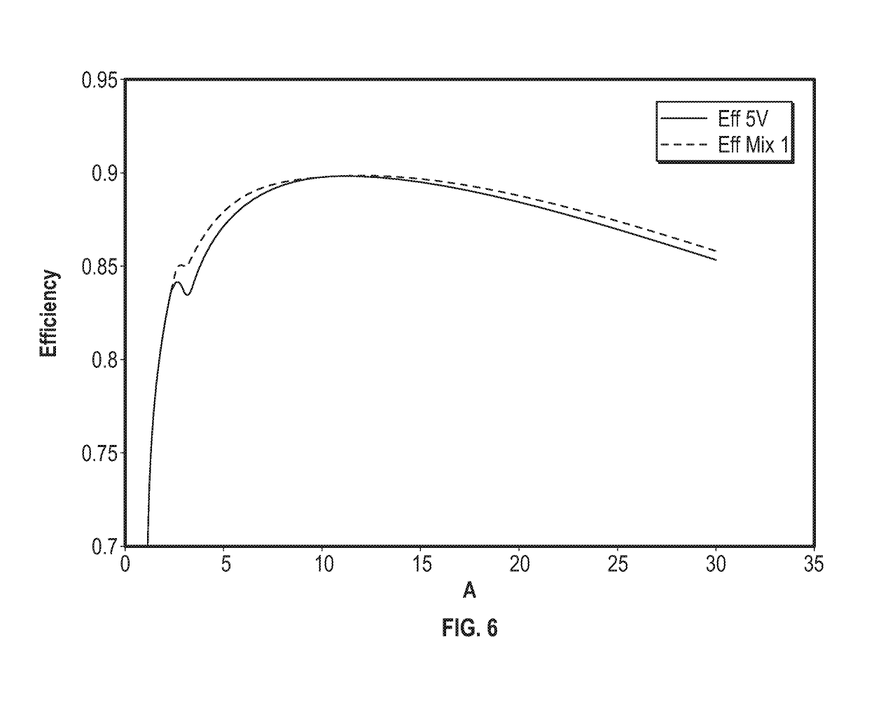

In a next step, the low side gate drive voltage remains fixed at 7V, while the high side gate drive voltage is varied between 4V and 7V in 0.5V increments. The resulting recorded data is shown in FIG. 5. The highest efficiency results for a high side gate drive voltage of 4V until a load current of 11A is reached, followed by a gate drive voltage of 7V for the remainder of the load currents. FIG. 6 shows the efficiency difference between a fixed gate drive voltage of 5V, versus a mixed gate drive voltage of 4V and 7V, dependent on load current.

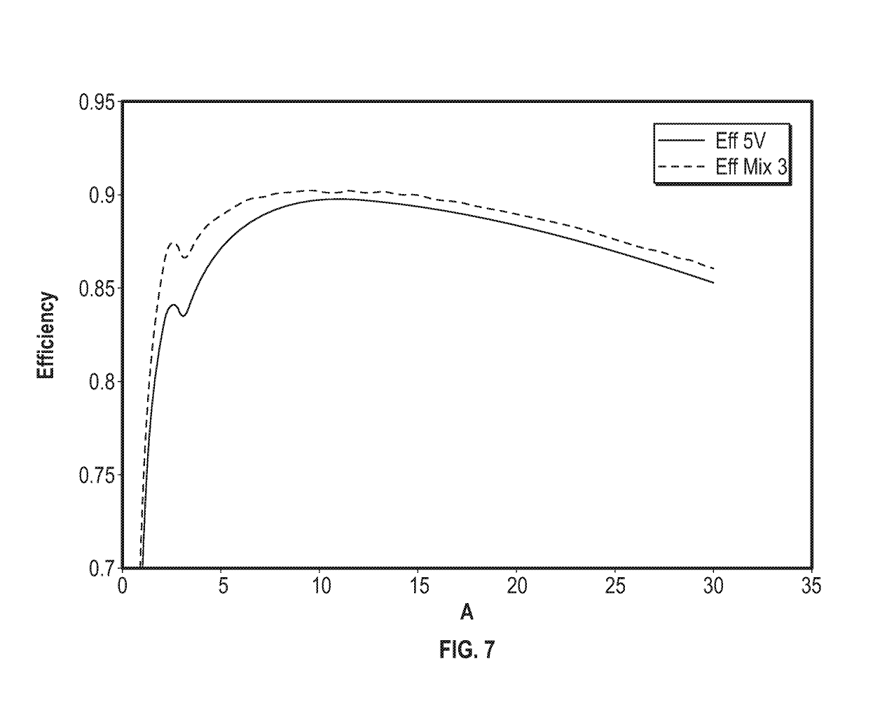

Once the separate gate drive voltages have been determined and in a further step, the output load is varied based on the determined optimal gate drive voltages, i.e., 7V for the low side gate drive voltage and mixed 4V/7V for the high side gate drive voltage. The recorded data is shown in the graph of FIG. 7. As can be seen from the FIG., the combination of the optimized gate drive voltages result in a significantly higher overall efficiency, than in case of an operation of the MOSFETs 5 and 6 with a standard gate drive voltage of 5V. As will be apparent, the efficiency optimization procedure, discussed in the preceding, requires independent control of the gate drive voltages of MOSFETs 5 and 6, which in this embodiment is realized by the controllable voltage sources 20 and 22.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module, or other unit may fulfill the functions of several items recited in the claims.

The mere fact that certain measures are recited in mutually different dependent claims does not indicate that a combination of these measured cannot be used to advantage. Any reference signs in the claims should not be construed as limiting the scope.

### APPENDIX

The present disclosure relates voltage conversion and, more particularly, to variable gate drive controller topology.

Embodiments of the present disclosure include voltage converters implemented in any suitable electronic device such as a microcontroller, voltage adapter, or power regulator. Embodiments of the present disclosure may be implemented with a variable gate drive controller topology. By adjusting the gate drive of FETs in the controller, the efficiency of voltage conversion may be increased.

In typical solutions, the gate drive is determined by LDO voltage output in controller. Typically, FETs have an “optimized” gate drive voltage wherein they are characterized. However, the range of valid gate drive voltages is much wider.

FIGS. 1 and 2 is an illustration of a variable gate drive topology, according to embodiments of the present disclosure.

Gate drive may be determined by LDO high side and LDO low side in controller. The LDO target voltage may be set by a controller core. The gate drive may be set independently for the high side and for the low side. The complexity of the gate drive voltages may be varied. This complexity may include respective values for the high side and low side. The complexity may be varied according to operating conditions with respect to frequency, voltage output, and current output. The settings of the high side and low drive may be set in, for example, look-up tables. The table may be of n dimensions for given, available parameters. The settings may be function based, wherein the settings are functions of the input parameters. The settings may be optimized or otherwise changed in software, or manipulated by an end user. For MCM power stages or modules with inductors, the settings may be optimized.

The controller may be implemented by analog circuitry, digital circuitry, instructions for execution by a processor, or any suitable combination thereof.

FIGS. 3-7 illustrate example results from a test board using the controller of FIG. 2.

The present disclosure has been described in terms of one or more embodiments, and it should be appreciated that many equivalents, alternatives, variations, and modifications, aside from those expressly stated, are possible and within the scope of the disclosure. While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein.

A power converter may comprise a high side driver circuit configured to generate a gate drive high side voltage signal to a gate of a first transistor; a low side driver circuit configured to generate a gate drive low side voltage signal to a gate of a second transistor coupled to the first transistor; an LDO low side input configured to output a VDD low-side signal to the low side driver circuit; and an LDO high side input configured to output a VDD high-side signal to the high side driver circuit; wherein a combination of the first transistor and the second transistor generates an output voltage.

In some embodiments, the LDO low side input and the LDO high side input are separately and independently controlled.

In some embodiments, the LDO low side input and the LDO high side input are based upon one or more of frequency, voltage output, and current output.

In some embodiments, the LDO low side input and the LDO high side input are selected from a lookup table based upon input parameters.

What is claimed is:

1. A circuit arrangement for switched mode power conversion, comprising at least:
an input for receiving an input voltage from a power supply;
an output to provide an output voltage to a load;
an energy storage device;
a plurality of controllable switching devices;
a first controllable voltage source, configured to provide a first control voltage to one or more of the plurality of controllable switching devices; and
at least a second controllable voltage source, configured to provide a second control voltage to one or more of the plurality of controllable switching devices; wherein
the first and the second controllable voltage sources are configured to allow independent control of the first and second control voltages.

2. The circuit arrangement of claim 1, wherein the first control voltage is provided to a first subset of one or more of the plurality of controllable switching devices and the second control voltage is provided to a second subset of one or more of the plurality of controllable switching devices, wherein the first subset and the second subset are mutually exclusive.

3. The circuit arrangement of claim 1, comprising a plurality of controllable voltage sources, wherein for each of the plurality of controllable switching devices, a dedicated controllable voltage source is arranged to provide a corresponding control voltage to the respective controllable switching device.

4. The circuit arrangement of claim 1, wherein at least some of the controllable switching devices are semiconductor switching devices having a control input and wherein the respective control voltage is provided to the control input of the associated switching device.

5. The circuit arrangement of claim 1, wherein at least some of the controllable switching devices are FET devices.

6. The circuit arrangement of claim 1, wherein one or more of the controllable voltage sources comprise at least one low-dropout regulator.

7. The circuit arrangement of claim 1, wherein the controllable voltage sources are configured to receive an input signal, corresponding to the input voltage, and wherein the respective control voltage depends on the input signal.

8. The circuit arrangement of claim 7, wherein the controllable voltage sources are configured to receive reference signals, and wherein the respective control voltage depends on the respective reference signal and the input signal.

9. The circuit arrangement of claim 8, further comprising a digital controller, which digital controller is configured to provide the reference signals to the controllable voltage sources.

10. The circuit arrangement of claim 9, wherein the digital controller is configured to control the reference signals for improved efficiency of the circuit arrangement.

11. The circuit arrangement of claim 9, wherein the digital controller is configured to control the reference signals based on one or more of frequency, voltage output, and current output.

12. The circuit arrangement of claim 9, wherein the digital controller comprises a user interface that allows configuration of the reference signals.

13. The circuit arrangement of claim 1, further comprising an analog controller, wherein the controllable voltage sources are integrally formed with the analog controller.

14. The circuit arrangement of claim 1, wherein the circuit arrangement is a synchronous switched mode power converter.

15. The circuit arrangement of claim 14, wherein the circuit arrangement comprises a high side controllable switching device and a low side controllable switching device, wherein the first controllable voltage source is configured to control the high side controllable switching device and the second controllable voltage source is configured to control the low side controllable switching device.

16. A control circuit for a switched mode power converter with a plurality of controllable switching devices, the control circuit comprising at least:
a first controllable voltage source, configured to provide a first control voltage to one or more of the plurality of controllable switching devices; and
at least a second controllable voltage source, configured to provide a second control voltage to one or more of the plurality of controllable switching devices; wherein
the first and the second controllable voltage sources are configured to allow independent control of the first and second control voltages.

17. A method of control of a circuit arrangement for switched mode power conversion, the circuit arrangement comprising at least a plurality of controllable switching devices; the method comprising
providing a first control voltage to one or more of the plurality of controllable switching devices; and
providing at least a second control voltage to one or more of the plurality of controllable switching devices; wherein
the first and the second controllable voltage sources are independently controlled.

18. A machine-readable medium including contents that are configured to cause a control circuit to conduct the method of claim 17.

19. A method of control of a circuit arrangement for switched mode power conversion, the circuit arrangement comprising one or more controllable switching devices; the method comprising
providing a first control voltage to a first subset of the one or more controllable switching devices; and
optimizing the first control voltage for increased efficiency of the circuit arrangement.

20. The method of claim 19, wherein the circuit arrangement comprises a plurality of controllable switching devices, the method further comprises
providing at least a second control voltage to a second subset of one or more of the plurality of controllable switching devices, wherein
the first and second subsets of controllable switching devices are mutually exclusive, and wherein
during optimizing the first control voltage, the second control voltage is maintained at a fixed control voltage level.
